(19) United States
(12) Patent Application Publication
(10) Pub. No.: US 2011/0319004 A1
(43) Pub. Date: Dec. 29, 2011

(54) Malodor air exhaust system

(76) Inventor: Hong Min Kim, Scarborough (CA)

(21) Appl. No.: 12/803,431

(22) Filed: Jun. 28, 2010

(51) Int. Cl. B60H 1/00; B60H 1/24

(52) U.S. Cl. 454/75; 454/162

(57) ABSTRACT

The exhaust system is for removing malodor flatulence air expelled by a person sitting in a seat. The gas sensor and the control module are provided in the form an integral unit removably mounted to a manifold incorporated in or under the seat. The gas sensor is removably mounted either to the side wall or at a bottom portion of the manifold. A sensor fan is provided close to the intake opening of the manifold for drawing the flatulence air into the system as soon as it is expelled by the person.

### BACKGROUND OF THE INVENTION

1. Field of the Invention

This invention relates to an air exhaust system and particularly to an exhaust system for effectively removing malodor flatulence discharged by a person sitting in a seat located in an enclosed area.

2. Background Art

Air exhaust systems are commonly provided for an interior area particularly in a space restrictive interior area such as a room or the cabin of an automobile. Such systems are primarily for removing stale air from the area and replacing it with fresh air from the outdoor atmosphere. They largely consist of an air intake port located at the side wall or ceiling of the area, and a duct connected from the intake port to an exhaust port communicating with the outdoor atmosphere. A blower fan is located in the duct to draw the stale air from the interior area to release it to the outdoor through the exhaust port. Such systems are not feasible for removing obnoxious malodor flatulence expelled by a person sitting in a seat located in an enclosed area; as the obnoxious smell of the flatulence would migrate completely into the interior area before it is slowly drawn away by the exhaust system. Thus, the obnoxious smell of the flatulence would be imbued and inhaled by other people located in the same area before it, is subsequently and slowly replaced with outdoor fresh air.

Most people produce about 1-3 pints of flatulence and pass the odor gas about 14 times a day. Flatulence itself, although not life threatening, can definitely cause social embarrassment. A person who breaks wind in public is generally ridiculed and even shunned in social circles. This embarrassment is often the reason why one might seek solutions for passing gas in public.

An exhaust system is shown in pending U.S. patent application Ser. No. 11/903,699 by the Applicant of this application operative for the above purposes. However, the system is difficult to incorporate into an automobile or a room since extensive changes must be made in the automobile or the building structure. The present invention provides an improved system which is more effective in removing malodor flatulence as well as filtering the interior air in a warm up mode in an enclosed area.

### SUMMARY OF THE INVENTION

It is a principal object of the present invention to provide an exhaust system which is effective in removing flatulence discharged by a person sitting in a seat located in an enclosed compartment or room.

It is another object of the present invention to provide an exhaust system which operates to filter the air in the enclosed compartment or room in a warm up mode.

It is another object of the present invention to provide an exhaust system having a sensor and control components fabricated in an integral unit which can be readily and easily incorporated in a seat located in and automobile or an enclosed compartment or room in a building.

It is yet another object of the present invention to provide an exhaust system in which the integral unit of the gas sensor and the control module is removably mounted such that it may be easily and readily removed for maintenance and replacement purposes.

### BRIEF DESCRIPTION OF THE DRAWINGS

These and other features of the invention will become more apparent from the following description in which reference is made to the appended drawings, in which

FIG. 1 is a top front perspective elevation view of the exhaust system of the present invention incorporated in two seats.

FIG. 2 is a perspective view showing the basic construction of the exhaust system according to the present invention with the gas sensor located in the intake manifold adjacent to the intake opening in the seat.

FIG. 3 is a perspective view showing the alternative construction of the exhaust system with the gas sensor mounted at an alternative bottom location of the intake manifold, and the assembly from three additional seats are connected to the extension duct of the system.

FIG. 4 is a schematic block diagram showing the system of the present invention.

FIG. 5 is a schematic diagram of the gas sensor supporting circuit of the system of the present invention.

FIG. 6 is a perspective enlarged side elevation view of a gas sensor provided with an adjustable extension tube for mounting it in a seat with a resilient or soft seat top portion.

### DETAILED DESCRIPTION OF THE PREFERRED EMBODIMENTS

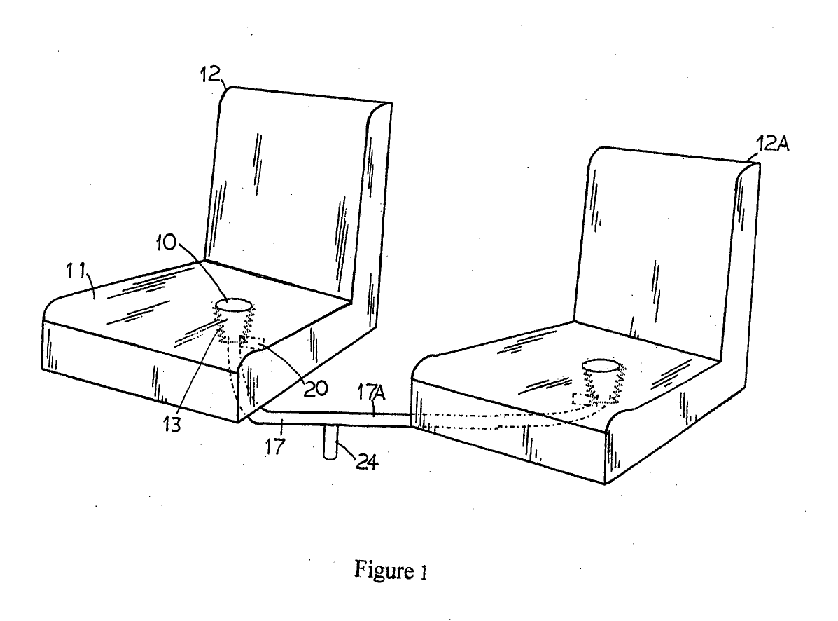

With reference to the drawings, FIG. 1 shows an air intake opening 10 formed in the top portion 11 of a seat 12. The intake opening 10 is preferably oval in shape having a minimum 10 cm large diameter and it is located at the center of the seat directly at the sitting location of the person in the seat such that flatulence from the person would directly be passed into the intake opening 10. For a seat having a hard top portion, the intake opening 10 may be covered with a screen or grate having a plurality of openings, and for a seat having a soft top portion provided with a covering sheet material, a plurality of venting perforations may be formed in the sheet material for the same purposes. An inlet vent coupling 13 is mounted below the intake opening 10 of the seat. The inlet vent coupling 13 is in the form of an inverted frusto-conical collapsible tubing having a larger upper end 14 of the same shape and dimensions of the intake opening 10 and a circular bottom end 15 smaller in diameter than the upper end. The upper end of the inlet vent coupling 13 is mounted to the intake opening 10 of the seat 12. The inverted frusto-conical shape of the inlet vent coupling 13 enhance the flow of air from the intake opening 10 into the coupling.

The bottom end 15 of the inlet vent coupling 13 is connected to an upper end 16 of an L-shaped manifold 17. A sensor fan 18 is optionally mounted transversely at the mounting between the inlet vent coupling 13 and the upper end 16 of the manifold 17. The sensor fan 18 is operative to draw air and flatulence from the intake opening 10 into the L-shaped manifold 17.

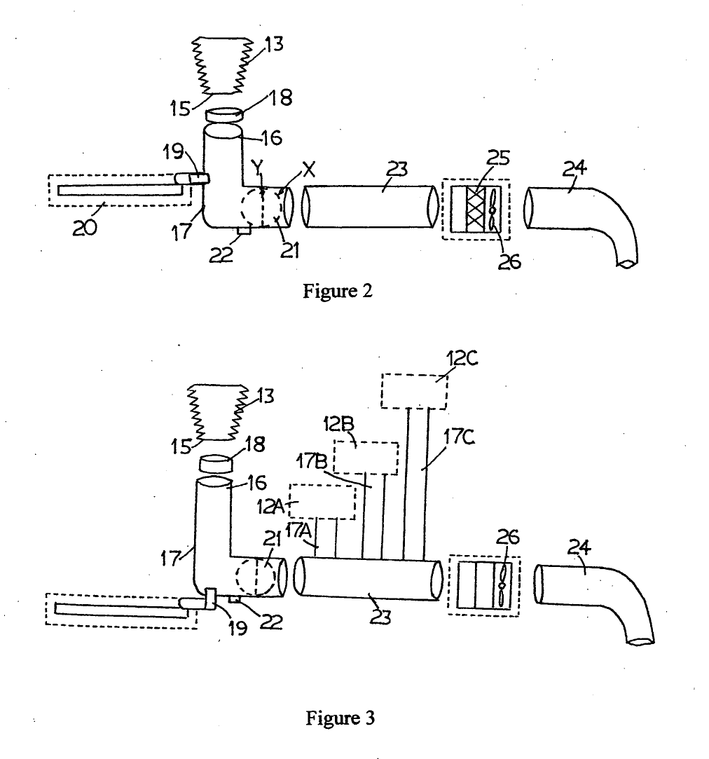

A gas sensor 19 is mounted at the side wall of the L-shaped manifold 17 as shown in FIG. 2 and located in a close proximity to the intake opening 10 so that it would detect the flatulence as soon as it is discharged and drawn into the inlet vent coupling 13 by the sensor fan 18. The gas sensor 19 is capable of detecting malodor gas concentrations between 1 and 100 ppm and the sensitivity of the system trigger point is adjustable. It has very little hysteresis and low power consumption. The gas sensor 19 is inserted through the side wall of the manifold 17 through a Teflon(trade mark) sleeve which serves both as a heat shield for the sensor and a pressure seal to maintain the air flow within the venting system. The gas sensor 19 is connected to an electrical control module 20 for the system of the present invention. The gas sensor and the control module may be fabricated in an integral assembly which can be easily and readily and removably installed in a compartment formed inside the seat or is simply located under the seat. In the latter case, the gas sensor 19 would be inserted through the bottom side wall of the manifold 17 as shown in FIG. 3.

A damper 21 is provided in the manifold 17 and it is located adjacent to the lower outlet end of the manifold 17. The damper 21 has dimensions equal to the internal dimensions of the manifold 17 and it is operatively controlled by the control module 20 to locate either in a first position X parallel to the axis of the lower portion of the manifold so as to allow air from flowing to the outlet end of the manifold or in a second position Y transverse to the axis of the manifold so as to block air from flowing to the outlet end. A secondary clean air outlet 22 is located at the side wall of the manifold 17 in front of the damper 21 so that when the manifold is blocked by the damper 21 located in the Y position, air would flow out of the manifold through the secondary clean air outlet 22 back into the enclosed area in which the seat is located. This provision permits clean air without odor to be circulated in the enclosed area in an idle mode of the system.

As shown in FIG. 2, an extension duct 23 is provided to connect the outlet end of the manifold 17 to an outlet duct 24 for passing the undesirable air to the outdoor atmosphere. An air filter 25 can be optionally mounted between the extension duct 23 and the outlet duct 24 to clean the malodor air prior to releasing it to the outdoor atmosphere. Alternatively, the air may be returned to the enclosed area after the malodor having been filtered. A single blower fan 26 with high throughput may also be provided at the air filter 25 or multiple fans may be incorporated close to the end of the exhaust vent for enhancing the drawing of the exhaust air to the outdoor atmosphere without filtering.

A second seat 12A having similar assembly and having a separate manifold 17A may be incorporated into the system by connecting the manifold 17A to the main extension duct 23. Also, a plurality of seats 12A, 12B, and 12C may also be included in the system by connecting their manifolds 17A, 17B and 17C to the main extension duct 23 as shown in FIG. 3.

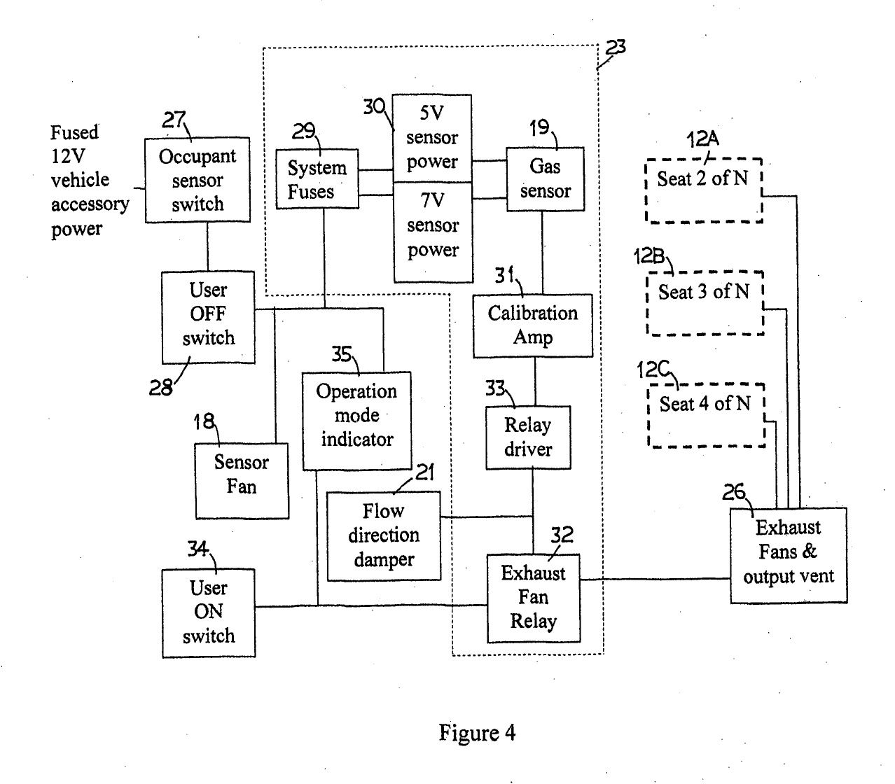

The construction of the control module 20 and the overall electrical operation system of the system of the present invention for an automobile as an exemplary embodiment is best shown in FIG. 4. The system of the present invention is actuated when a person is sitting in the seat 12 with the automobile ignition turned on to either the accessory power or with the vehicle started. The weight of the person actuates an occupant sensor switch 27, such as a power interlock micro-switch mounted under the top of the seat, to permit the system to be operated by the electrical power supply of the automobile. The sensor fan 18 will operate as soon as the power is turned on and the system will operate after a short initial warm up period so that air in the enclosed area is circulated through the enclosed area in a standby mode with the damper 21 located in the closed position and the clean air is returned into the enclosed area through the secondary clean air outlet 22. The standby mode with the sensor fan 18 operating continuously also enhances the efficiency of the system in drawing the flatulence into the manifold 17 as soon as it is expelled by the person sitting in the seat. A manually operative first override switch 28 is provided for the operator of the automobile to turn off the sensor fan 18 and the system if they are not desired.

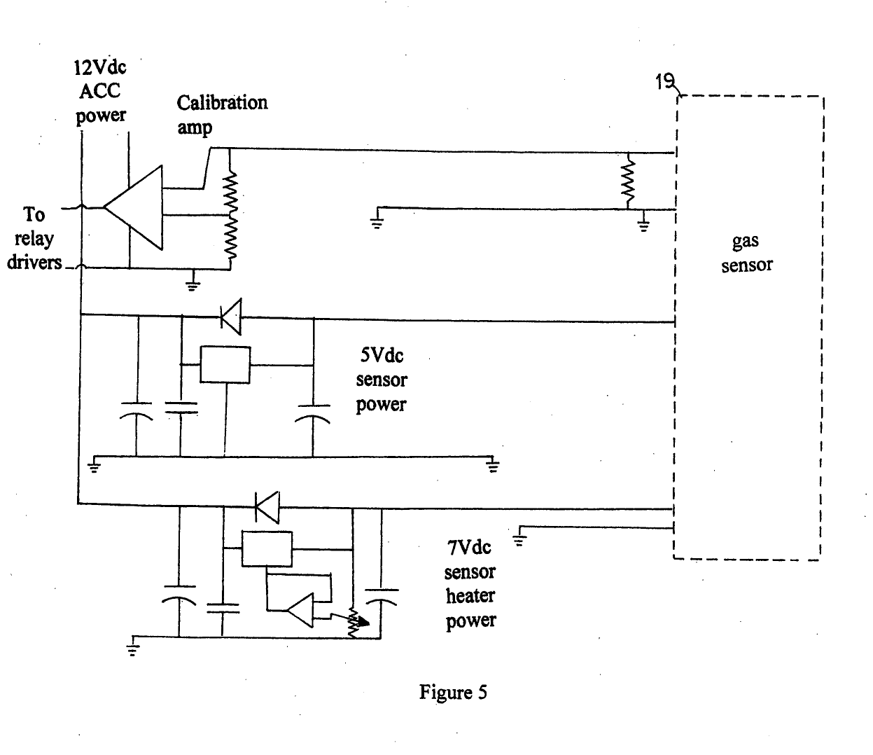

As shown in FIGS. 4 and 5, the control module 20 is also turned on by the power supply through system fuses 29 of the automobile so as to actuate the gas sensor 19 which is shown as an integral unit with the control module 20. The gas sensor 19 is powered by an adjustable DC power supply set and fixed at 7 Vdc for heater power and it is excited by a fixed 5 Vdc power supply. With these two sensor supply voltages, the sensor output range is between 1 Vdc and 4 Vdc which corresponds to approximately 1 ppm to 100 ppm of malodor air concentrations respectively. The sensor output is calibrated to drive a Darlington transistor array which in turn drives the control relay. This calibration is achieved by the use of a single Operational Amplifier that is referenced by a voltage divider to its negative input and compares that to the sensor output that is presented to the positive input. The output of this OP Amp calibration circuit drives the Darlington transistor relay drivers.

The sensitivity of the gas detection of the system may be adjusted with a calibration amplifier 31. The gas sensor 19 will turn on the exhaust fan 26 through the exhaust fan relay 32 and the relay driver 33. In the mean time, the damper 21 is also operated by the relay driver 33 to locate in the opened position X when the exhaust blower fans 26 are operated so that malodor air is drawn out of the automobile to the outside atmosphere or returned to the cabin after having been filtered. The system would operate in the malodor air exhaust mode as long as the gas senor 19 is still detecting the existence of malodor air. The exhaust fans 26 may also be operated for a selected period of time continuously by the operator by turning on a second override switch 34. A mode indicator 35 may be provided for displaying whether the system is operating under the automatic mode, or it is operating in either one of ON or Off override mode, and whether the filter, if provided, requires replacement. The indicator 35 can be mounted in a visible location such as at the dash or the seat arm rest of the automobile. The power supply to the control module also may be turned on when the ignition switch of the automobile is turned to accessories or the start position.

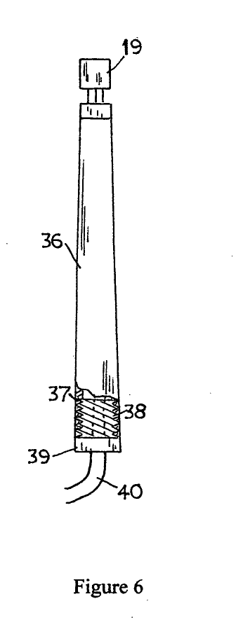

When the exhaust system of the present invention is used in a seat with a soft or resilient seat top portion with the gas sensor mounted in a vertical manner at the bottom of the manifold, due to the variations in seat thickness, firmness and occupant weight, an adjustable mounting tube may be provided for locating the gas sensor in the seat. As shown in the exemplary embodiment best shown in FIG. 6, the adjustable mounting tube may be in the form of a tapered tube 36 having a threaded lower end portion 37. The extension tube 36 is threadingly mounted threaded upper portion 38 of a base 39 provided at the control module. The gas sensor is, in turn, mounted at the top of the extension tube 36. The height of the gas sensor extending upward into the seat may thus be adjusted by turning the extension tube relative to the base 39. The lead wires 40 of the gas sensor extend through the mounting base 38 for connection to the control module.

As shown in the above preferred embodiment, the gas sensor 19 and the control module 23 are formed in an integral assembly. It can be understood that the gas sensor may be provided separately with its lead wires connected to the control module.

While the present invention has been shown and described in the preferred embodiments thereof, it will be apparent that various modifications can be made therein without departing from the spirit or essential attributes thereof, and it is desired therefore that only such limitations be placed thereon as are imposed by the appended claims.

What is claimed is:

1. An exhaust system for removing flatulence malodor air comprising,
a seat having an air intake opening formed in a seat top for accommodating a person to be seated therein, said seat being located in an enclosed area,
a manifold tubing mounted to said seat, said manifold having an upper end connected to said intake opening,
a sensor fan optionally mounted between said upper end of said manifold and said air intake opening, and operative for drawing flatulence malodor air into said manifold as soon as said air is expelled by the person sitting in said seat,
a gas sensor removably mounted to and extending into said manifold for detecting existence of said flatulence malodor air in said manifold,
a control module connected to said gas sensor and said sensor fan and operative for operating said gas sensor and said sensor fan,
a damper located in said manifold, said damper being operative by said control module to locate in a first position parallel to the longitudinal axis of said manifold for said flatulence malodor air to flow through to an outlet end of said manifold, and in a second position transverse to the longitudinal axis of said manifold for blocking air to flow through said manifold,
a secondary air outlet formed at a side wall of said manifold and located upstream of said damper, and operative to release clean air from said manifold,
an outlet duct connected to said manifold for, conducting malodor air from said manifold to outdoor atmosphere.

2. An exhaust system according to claim 1 wherein said seat is provided with a soft seat top, and a collapsible coupling tubing is mounted in said seat and located between said intake opening of said seat and said manifold.

3. An exhaust system according to claim 2 wherein said collapsible coupling tubing has an inverted frusto-conical shape with a larger upper end connected to said intake opening of said seat and a smaller lower end connected to an upper end of said manifold.

4. An exhaust system according to claim 1 wherein said gas sensor and said control module is fabricated in the form of an integral unit removably mountable to said manifold in said seat.

5. An exhaust system according to claim 4 wherein said manifold is an L-shaped tubular tubular member having a generally vertical upper portion and a generally horizontal lower portion.

6. An exhaust system according to claim 5 wherein said gas sensor is removably mounted to a side wall of said vertical upper portion of said manifold.

7. An exhaust system according to claim 5 wherein said gas sensor is removably mounted at said horizontal lower portion and located directly below said vertical upper portion with said gas sensor extending upwardly into said manifold.

8. An exhaust system according to claim 5 including a filter mounted between said manifold and said outlet duct and operative for cleaning said flatulence malodor air prior to releasing to the outdoor atmosphere.

9. An exhaust system according to claim 8 wherein said outlet duct conducts said malodor air after having been cleansed by said filter to removed said malodor, back into said enclosed area.

10. An exhaust system according to claim 5 including at least a blower fan mounted between said manifold and said outlet duct and operative for enhancing the release of the flatulence malodor air to the outdoor atmosphere.

11. An exhaust system according to claim 3 including an interlock switch mounted in said seat and being operative to connect said system to a power supply for actuating said gas sensor and said sensor fan when a person is sitting on said seat.

12. An exhaust system according to claim 10 including a manually operated first override switch connected to said control module and being operative for actuating said system continuously.

13. An exhaust system according to claim 12 including a manually operated second override switch connected in series with said power supply and said control module and being operative for disabling said system.

14. An exhaust system according to claim 7 wherein said gas sensor is mounted to the control module with an extension tube adjustable to vary the height of said gas sensor extending upwards into said manifold.

15. An exhaust system according to claim 14 wherein said extension tube is a tapered tube having a threaded lower end portion threadingly engageable with complementary mounting threads provided on a mounting base, said tapered tube being adjustable relative to said mounting base to vary the position of said gas sensor extending upwardly in said manifold.
